(19) United States
(12) Patent Application Publication
(10) Pub. No.: US 2003/0173020 A1
(43) Pub. Date: Sep. 18, 2003

(54) Substrate laminating apparatus and method

(75) Inventor: Eiichi Ishiyama, Zama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SHIBAURA MECHATRONICS CORPORATION, Yokohama-shi (JP)

(21) Appl. No.: 10/369,725

(22) Filed: Feb. 21, 2003

(30) Foreign Application Priority Data
Feb. 22, 2002 (JP) P2002-046691
Feb. 19, 2003 (JP) P2003-041664

(51) Int. Cl. B44C 1/00

(52) U.S. Cl. 156/235

(57) ABSTRACT

For the vacuum pumping performed for a chamber, the opening of a valve communicating with a vacuum pump is controlled to change the intake resistance of a pipe from high to low, and to suppress an exhaust air stream occurring when vacuum pumping is started. Further, in the process (vacuum venting) for recovering the atmospheric pressure in the chamber, a recovery valve is controlled to change, from high to low, the inflow resistance of a gas introduced into the chamber, so that the amount of the gas introduced into the chamber 2 at the beginning of the vacuum venting is reduced. Therefore, since the air stream in the chamber 2 can be moderated during the vacuum pumping and the vacuum venting, the deterioration of the electric characteristics of the substrates by the stirring up of dust in the chamber and the attachment of the dust to the substrates can be avoided, and high-quality laminated substrates can be provided at a high manufacturing yield.

### BACKGROUND OF THE INVENTION

1. Field of the Invention

The present invention relates to a substrate laminating apparatus appropriate and a substrate laminating method for manufacturing a liquid crystal display panel 2.

2. Description of the Related Art

Generally a liquid crystal display panel used as a display device for a personal computer, a TV receiver or a monitor is manufactured by laminating a pair of opposing glass substrates on which an adhesive coating has been applied to enclose the display surfaces.

The liquid crystal display panel is fabricated by filling the display surfaces between the two laminated substrates with liquid crystal Two methods, a liquid crystal dip method and a liquid crystal dispenser method, are available that can be employed to seal liquid crystal between display surfaces. With either method, substrates are laminated after spraying or arranging multiple spacers on one of the substrates, so that a constant gap (a cell gap) is obtained between the substrates, which is then filled with the liquid crystal.

### SUMMARY OF THE INVENTION

FIG. 1 is a partially cutaway, cross-sectional view of an earlier substrate laminating device used for manufacturing a liquid crystal display panel that employs the liquid crystal dispenser method.

As is shown in FIG. 1, a pair of upper and lower, rectangular shaped glass substrates 1a and 1b, are arranged in a chamber 2 formed of upper and lower chambers 2a and 2b. The upper substrate la is held on the lower face of an upper stage 3a by holding means, such as a chuck. For the lower substrate 1b. droplets of liquid crystal 4 are deposited on the display surface, while a sealing material 5, an adhesive, is applied to enclose the display surface. The lower substrate 1b is held by the same holding means, such as a chuck, as is used for the upper substrate 1a. Spacers 5a are dispersed on the display surface.

The upper stage 3a is connected to and supported by a support shaft 6a of a moving mechanism 6. The upper stage 3a can be moved by the moving mechanism 6 in X-Y-6 directions. When the upper stage 3a is moved by the moving mechanism 6 vertically to the X-Y-d directions (as indicated by the double headed arrow Z), the upper stage 3a positions the upper substrate 1a over the lower substrate 1b, and presses the upper substrate 1a down to laminate and paste the substrates 1a and 1b.

The lower stage 3b is fixed to a lower chamber 2b, and in the lower chamber 2b, image pickup cameras 71 and 72 are provided to support the positioning of the upper and lower substrates 1a and 1b.

The image pickup cameras 71 and 72 photograph positioning marks (alignment marks) provided on the substrates 1a and 1b, and supply the thus obtained images to a controller (not shown). Thereafter, the controller detects the positions of the marks using a so-called pattern recognition method, and the moving mechanism 6 conducts alignment of the relatively position of the upper and lower substrates 1a and 1b based on the detected marks.

Although a driving mechanism is not shown, the upper chamber 2a is set up so it can be moved vertically, and when the upper chamber 2a descends and is brought into contact with the lower chamber 2b, the structure, overall, is tightly closed and defines a closed space. Further, a vacuum pump (not shown) is connected to a pipe 21, which opens into the chamber 2 and is used to exhaust the air in the chamber 2 to evacuate therein. Finally, an elastic member 2c, which is securely fixed to the lower end of the upper chamber 2a, forms an airtight seal when the upper and lower chambers 2a and 2b are closed, and a conveying rail 22 is provided that is used to move the lower chamber 2b.

In the processing performed to manufacture a liquid crystal display panel using thus arranged substrate laminating device, the following procedures (steps) are employed to laminate the upper and lower substrates 1a and 1b.

First, the upper substrate la is placed on the lower stage 3b of the lower chamber 2b and is carried in and held on the lower face of the upper stage 3a by a vacuum. Then, the lower substrate 1b, to which a coating of the sealing material 5 has been applied in advance to enclose the liquid crystal 4 on the display surface, is held on the lower stage 3b of the lower chamber 2b by a vacuum and is carried in.

Next, the upper chamber 2b descends to form a closed space, and in accordance with the change represented by a characteristic curve in FIG. 2, and a vacuum is established in the chamber 2 by using the vacuum pump connected to the pipe 21 to exhaust the air therein. Following this. in the vacuum in the chamber 2, the upper substrate 1a is positioned relative to the lower substrate 1b, and is pressed onto the lower substrate 1b by the descent of the upper stage 3a. As a result, through the sealing material 5, the substrates 1a and 1b are laminated and pasted each other.

Finally, after the atmospheric pressure has been recovered by the vacuum venting in the chamber 2, the vacuum holding of the upper substrate 1a on the upper stage 3a is released and the upper chamber 2a is elevated. Thereafter, the two substrates 1a and 1b laminated on the lower stage 3b are discharged.

As is described above, since the two substrates 1a and 1b, which were laminated in the vacuum. are now exposed to atmospheric pressure, there is a large difference between the pressure applied to the display surfaces of the substrates 1a and 1b in the vacuum and in the current environment, i.e., between the pressure within the cell spaces and the external atmospheric pressure, Thus, the substrates 1a and 1b are pushed against the spacers 5a and form gaps (cell gaps) with an accuracy represented by the micron unit.

After the substrates 1a and 1b have been laminated and pasted by the sealing material 5. the sealing material 5 is cured by heating or by ultraviolet (UV,) irradiation.

As is described above, for the earlier substrate laminating device used for manufacturing a liquid crystal panel and the like, in the closed space that is defined, the chamber 2, the upper substrate 1a, held on the upper stage 3a by a vacuum, is positioned relative to lower substrate 1b, and is laminated and pasted with the lower substrate 1b through the use of the sealing material 5, which is an adhesive.

At this time, since a vacuum is established in the chamber 2 by using the vacuum pump to exhaust the air therein, the laminating operation is performed in a vacuum.

During the pumping performed to produce a vacuum In the chamber 2, as is shown in FIG. 2, initially, the vacuum pump rapidly and forcibly exhausts the air from the chamber 2, and the vacuum level increases rapidly. However, as the air in the chamber 2 is gradually exhausted, while the pumping is continued and a desired vacuum L is approached, there is only a moderate increase in the vacuum level.

Since the attachment of dust and dirt to a display surface drastically deteriorates the display characteristics of a liquid crystal display panel, accordingly, an assembly process, such as substrate laminating, is performed in a clean room from which dust and dirt has been removed.

While it is desirable that a high degree of cleanliness is maintained in a manufacturing location, practically, it is impossible to completely remove all the dust and dirt in the air. And in addition, since the substrate laminating device includes mechanically movable sections, the production of new dust and the like by the mechanisms cannot be avoided, and residual dust and dirt cannot be completely removed in the chamber 2

Therefore when performing substrate laminating, and when the vacuum pump is operated to establish a vacuum in the chamber 2, initially, the extremely rapid exhaustion of air disturbs the air flow in the chamber 2, and thus produced turbulence may stir up residual dust and dirt in the lower chamber 2b that may be attached to the display surface of the lower substrate 1b.

In addition, the attachment of dust and dirt to the laminated substrates tends to deteriorate the electrical characteristics of the substrates. And when the vacuum venting In the chamber 2 is performed after an laminating, the air stream produced as the atmospheric pressure is recovered may stir up the dust and dirt in the chamber 2, and the dust and dirt may be attached to the electrode surface and interfere with the electric conductivity when connected to an IC and the like.

As the requests for high-definition display screens have increased in recent years, improvements are required that can prevent a reduction in the manufacturing yield, which occurs when tiny dust and dirt in the chamber 2 are stirred up due to the turbulence generated by the exhaustion of air or by the vacuum venting, and are attached onto the display surfaces or onto the electrodes.

It is, therefore, one objective of the present invention to provide a substrate laminating apparatus that can supply a preferable substrate by laminating upper and lower substrates in a vacuum chamber while avoiding, to the possible extent, the stirring up of dust and dirt, and a substrate laminating method therefore.

It is another objective of the present invention to prevent dropping of an upper substrate due to vacuum pumping performed in a chamber.

To achieve these objectives, according to a first aspect of the present invention, a substrate laminating apparatus for laminating two substrates in a closed chamber comprises:

a pump being connected to the chamber to perform vacuum pumping in the chamber; and

a controller for controlling a valve of a pipe connecting the pump to the chamber to change an intake resistance of the pipe.

As is described above, according to the first aspect of the invention, since the controller controls the valve of the pipe connecting the pump to the chamber, and changes the intake resistance of the pipe, extremely rapid vacuum pumping can be moderated, and the stirring up of dust and dirt can be suppressed.

According to a second aspect of the invention, a substrate laminating apparatus for laminating two substrates in a closed chamber comprises;

a pump being connected to a chamber to perform vacuum pumping in the chamber; and

a controller for controlling a recovery valve communicating with a recovery port opening in the chamber, and for changing an inflow resistance of a gas flowing into the chamber.

As is described above, according to the second aspect, in the process for recovering the atmospheric pressure in the chamber after substrates are laminated, the inflow resistance of the gas flowing into the chamber changes from high to low. Therefore, the recovery of atmospheric pressure is performed moderately in the chamber, and the stirring up of dust and dirt in the chamber can be reduced.

According to a third aspect of the invention, a substrate laminating method for laminating two substrates in a closed chamber comprises:

a first step of arranging a pair of substrates in the chamber, so that the substrates are opposing each other and keeping a space therebetween;

a second step, following the completion of the first step, of operating a pump connected to the chamber at a predetermined intake resistance, and of starting vacuum pumping in the chamber;

a third step of controlling a valve on a pipe connecting the pump to the chamber, so that the intake resistance of the pipe is reduced when a predetermined period of time has elapsed or the pressure in the chamber has reached to a predetermined value following the start of the vacuum pumping at the second Step;

a fourth step, following the completion of the third step, of laminating the two substrates arranged opposing each other in the chamber;

a fifth step, following the completion of the fourth step, of controlling a recovery valve communicating with a recovery port opening into the chamber, introducing a gas into the chamber at a predetermined inflow resistance, and shifting the internal gas pressure in the chamber toward the atmosphere pressure: and

a sixth step, following the completion of the fifth step, of extracting the two laminated substrates from the chamber.

According to the third aspect of the invention, when a predetermined period of time has elapsed or the pressure in the chamber has reached to a predetermined value following the start of the vacuum pumping at the second step, the valve of the pipe connecting the pump to the chamber is controlled so that the intake resistance of the pipe and the exhaust gas flow at the beginning are reduced. Therefore, as well as in the first aspect, the stirring up of dust and dirt in the chamber can be suppressed and the attachment of dust and dirt to the display surfaces of the substrates can be reduced.

According to a fourth aspect of the invention, a substrate laminating apparatus for laminating two substrates in a closed chamber comprises:

a pump connected to the chamber to perform vacuum pumping for the chamber; and

a controller for changing an intake capability of the pump.

As is described above. according to the fourth aspect, the controller is provided to change the intake capability of the pump that exhausts the gas in the chamber Since the controller changes the intake capability of the pump, as well as in the first aspect, the extremely rapid vacuum pumping performed in the chamber can be moderated and stirring up of dust and dirt can be suppressed.

According to a fifth aspect of the invention, a substrate laminating method for laminating two substrates in a closed chamber comprises:

a first step of arranging a pair of substrates in the chamber, so that the substrates are opposing each other and keeping a space therebetween;

a second step, following the first step, of operating a pump, connected to the chamber and having a predetermined intake capability, and beginning vacuum pumping for the chamber;

a third step of controlling the pump, an exhaust valve of the pump, or a valve on a pipe connecting the pump to the chamber, when a predetermined period of time has elapsed or the pressure in the chamber has reached to a predetermined value following the start of the vacuum pumping at the second step;

a fourth step, following the third step, of laminating the two substrates arranged opposing each other in the chamber;

a fifth step, following the fourth step, of controlling a recovery valve, which communicates with a recovery port opening into the chamber, so as to introduce a gas into the chamber at a predetermined inflow resistance, and of shifting the gas pressure in the chamber to the atmospheric pressure; and

a sixth step, following the fifth step, of extracting the two laminated substrates from the chamber.

According to the fifth aspect of the invention, the intake capability of the pump is increased when a predetermined period of time has elapsed or the pressure in the chamber has reached to a predetermined value following the start of the vacuum pumping at the second step. Therefore, as well as in the third aspect, the stirring up of dust and dirt in the chamber can be suppressed by setting a low exhaust air flow at the beginning, and the attachment of dust and dirt to the display surf aces of the substrates can be reduced.

### BRIEF DESCRIPTION OF THE DRAWINGS

FIG. 1 is a partially cutaway, front view of the essential section of a liquid crystal display panel manufacturing apparatus that employs an earlier substrate laminating apparatus;

FIG. 2 is a graph showing a characteristic curve obtained by the apparatus in FIG. 1 of a vacuum level in a chamber;

FIG. 3 is a partially cutaway, front view of a liquid crystal display panel manufacturing apparatus that employs a substrate laminating apparatus according to a first embodiment of the present invention;

FIG. 4 is a graph showing a characteristic curve obtained by the apparatus in FIG. 3 of a vacuum level in a chamber;

FIG. 5 is a graph showing a characteristic curve obtained by the apparatus in FIG. 3 when a gas is introduced into a chamber;

FIG. 6 is a flowchart showing the substrate laminating processing performed by the apparatus in FIG. 3;

FIG. 7 is a flowchart showing the processing performed by the apparatus in FIG. 3, beginning with the laminating of the substrates and continuing until the substrates are removed from the chamber;

FIG. 8 is a diagram showing the configuration of a liquid crystal display panel manufacturing apparatus that employs a substrate laminating apparatus according to a second embodiment of the present invention;

FIG. 9 is a diagram showing the configuration of a liquid crystal display panel manufacturing apparatus that employs a substrate laminating apparatus according to a third embodiment of the present invention:

FIG. 10 is a flowchart showing the processing performed by the apparatus in FIG. 9 for laminating substrates in a chamber;

FIG. 11 is a diagram showing the arrangement of a controller provided for a substrate laminating apparatus according to fourth and fifth embodiments of the present invention;

FIG. 12 is a flowchart showing the pressure control processing performed by the substrate laminating apparatus according to the fourth embodiment of the present invention; and

FIG. 13 is a graph showing a characteristic curve of a vacuum level in a chamber according to the fifth embodiment of the present Invention.

### DETAILED DESCRIPTION OF THE PREFERRED EMBODIMENTS

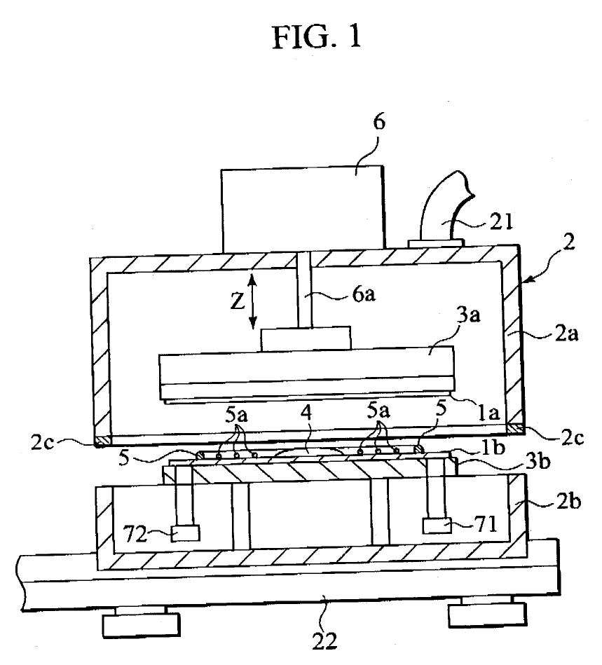

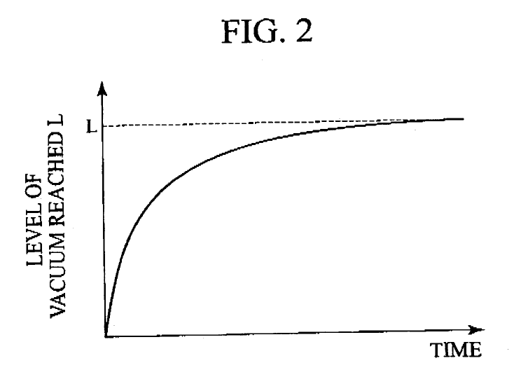

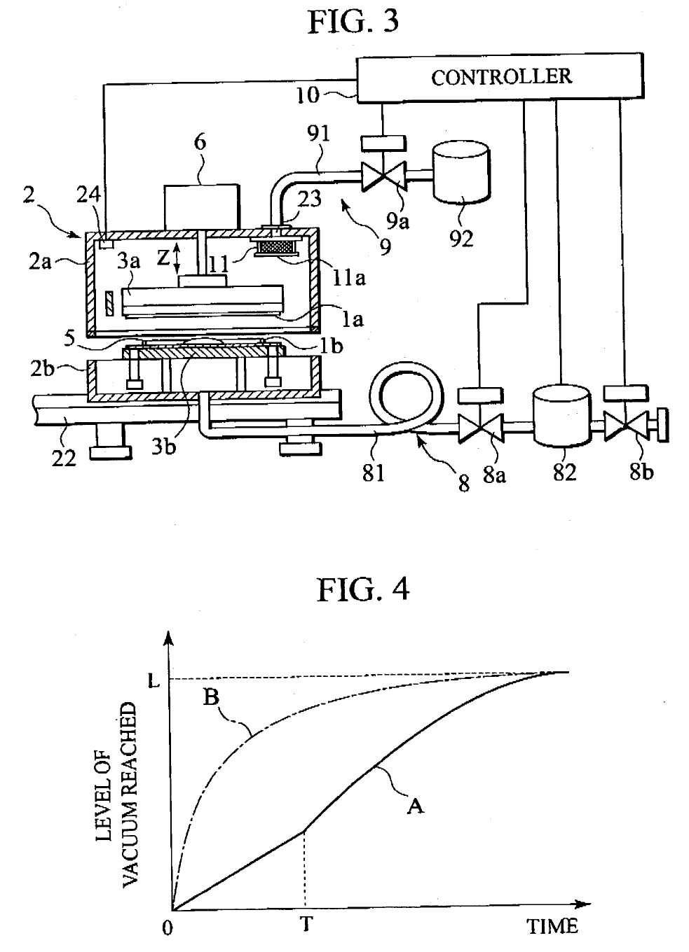

A substrate laminating apparatus and a substrate laminating method according to the preferred embodiments of the present invention will be described in detail while referring to FIGS. 3 to 8. The same reference numerals as are used for the earlier configuration in FIGS. 1 and 2 are employed to denote corresponding components, and no further explanation for them will be given.

FIG. 3 is a partially cutaway, cross-sectional view of a substrate laminating apparatus according to a first embodiment of the present invention that is employed to manufacture a liquid crystal display panel using a liquid crystal dispenser method. FIG. 4 is a graph showing a characteristic curve representing the change, under the valve control provided by the controller of the apparatus in FIG. 3, of a vacuum level in a chamber.

As is shown in FIG. 3, a pair of rectangular shaped upper and lower glass substrates 1a, 1b are arranged in a chamber 2. By the use of a vacuum or electrostatic holding means, the upper substrate la is held on the lower face of an upper stage 3a and the lower substrate 1b is held on the upper face of a lower stage 3b.

The upper stage 3a is connected to and supported by a moving mechanism 6 so as to be positioned in the X-Y-e direction and so as to be moveable vertically (in the Z axial direction). Therefore, In a closed space defined upon the connection of the upper chamber 2a and the lower chamber 2b, the upper and lower substrates 1a and 1b are positioned and then laminated and pasted using a sealing material 5. It should be noted that the lower stage 3b may be connected to and supported by the moving mechanism 6.

The upper and lower substrates 1a and 1b, thus laminated in the vacuum, are discharged by separating the upper substrate 1a from the upper stage 3a, by performing the vacuum venting in the chamber 2, and by elevating the upper chamber 2a. In the chamber 2, or after the laminated substrates 1a and 1b have been discharged along a conveying rail 22, the sealing material used for the laminating of both substrates 1a and 1b is cured by heat or by ultraviolet (IV) irradiation.

In the first embodiment, as means for exhausting the gas such as air in the chamber 2 and for performing the vacuum venting, an air exhaust mechanism 8 and an air supply mechanism 9 are connected to the chamber 2, and a controller 10, which serves as control means, controls these mechanisms 8 and 9.

The air exhaust mechanism 8 includes: a pipe 81, which is connected to and opens into the lower chamber 2b that moves along the conveying rail 22; and a vacuum pump 82, which is connected to the pipe 81. The controller 10 controls not only the vacuum pump 82, but also a valve 8a. provided for the pipe 81, and an emission valve 8b. provided for the exhaust pipe of the vacuum pump 82.

The air supply mechanism 9 includes: an inflow pipe 91 and a pressure source 92 connected to the inflow pipe 91. The inflow pipe 91 is connected to a recovery port 23 provided on the ceiling of the upper chamber 2a, and a recovery valve 9a for the inflow pipe 91 is controlled by the controller 10. The pressure source 92 is a pressure tank in which gases including inactive gas, such as nitrogen, are contained in the pressure source 92 to prevent the condensation of moisture that accompanies a sudden pressure change during vacuum venting.

As is shown in FIG. 3, an air filter 11 is mounted inside the upper chamber 2a having the recovery port 23 in order to cover that recovery port 23, and includes a plate 11a mounted opposite the recovery port 23 with an interval therebetween. Gas entering through the recovery port 23 is deflected by the plate 11a before passing through a horizontally enclosing net into the closed space.

Therefore, the air filter 11 serves as a type of louver mechanism that not only removes dust mixed in the gas flowing into the chamber 2, but also changes the direction of flow of the gas supplied through the recovery port 23 and prevents it from blowing directly into the large open space In the chamber 2.

With this configuration, the extraction of laminated substrates 1a and 1b is achieved by the vacuum pumping in the chamber 2, the positioning and laminating of the substrates 1a and 1b and the vacuum venting in the chamber 2. In this case, the vacuum pumping in the chamber 2 and the recovery of the atmospheric pressure through the vacuum venting in the chamber 2 are respectively performed by the air exhaust mechanism 8 and the air supply mechanism 9 under the control of the controller 10.

That is, in the vacuum processing controlled by the controller 10, first, the vacuum pump 82 is activated by closing the recovery valve 9a of the air supply mechanism 9 and opening the emission valve 8b of the exhaust mechanism 8, and by controlling the valve 8a so that, before a desired vacuum level is obtained, the changing of the pipe 81 resistance from high to low is accomplished in two steps.

Specifically, in the graph in FIG. 4 are shown a characteristic curve that continues until the desired vacuum level is reached in the chamber 2, and a curve produced when the controller 10 holds the valve 8a half open, for example, until a time t has elapsed, whereupon it fully opens the valve 8a.

Instead of using time as a parameter for controlling the valve 8a, internal chamber pressure (vacuum level) may be so employed. In this case, a pressure detector 24 is provided for detecting the pressure in the chamber 2. A pressure value detected by the pressure detector 24 is transmitted to the controller 10, and when this pressure value indicates a vacuum level that corresponds to the vacuum level at the time t in FIG. 4, the controller 10 fully opens the valve 8a.

As a result, during a period beginning with the opening of the valve 8a and ending upon the elapse of the time t, the amount of gas exhausted through the pipe 81 is reduced by restricting the opening of the valve 8a. Therefore, during the period beginning with the opening of the valve 8a and ending upon the elapse of the time t, the amount of air exhausted by the vacuum pump 82 is limited to that permitted by the high resistance provided by the pipe 81, and as indicated by a solid line A in FIG. 4. the change in the vacuum level in the chamber 2 is moderated.

More specifically, according to this embodiment, the change in the vacuum level is moderated, unlike the transition beginning with a sharp increase in the vacuum in the earlier chamber, which is indicated by a long dashed dot line B in FIG. 4. Therefore, during the vacuum pumping process, the speed of the exhaust air is stream in the chamber does not increase rapidly, and the stirring up of dust in the chamber 2 is avoided.

When the time t has elapsed, the controller 10 fully opens the valve 8a. At this time, since the vacuum level in the chamber 2 is considerably increased, a strong air exhaust stream does not occur, even when the valve 8a is fully opened to reduce the intake resistance of the pipe 81. Therefore, the stirring up of dust in the chamber 2 can be prevented, and the target vacuum level L can be reached.

When the target vacuum level L for the chamber 2 Is reached, the controller 10 closes the valve 8a and halts the operation of the vacuum pump 82. Since, as Is shown in FIG. 3, the pipe 81 is connected to the lower chamber 2b at an opening in the bottom plate thereof, and is laid below the lower chamber 2b, the air in the chamber 21 is sucked downward, so that the stirring up of dust when the air is exhausted can be more effectively suppressed.

After the substrates 1a and 1b are laminated. the controller 10 activates the air supply mechanism 9 to return the chamber 2 to the atmospheric pressure state from the vacuum state.

Then, the controller 10 opens the recovery valve 9a, and supplies a gas, such as air containing nitrogen gas, from the pressure source 92 to the chamber 2.

During this process, at the beginning the controller 10 sets the opening of the recovery valve 9a for example, to ¼, and fully opens the recovery valve 9a after a predetermined period of time T has elapsed. As a result, the inflow resistance for the gas introduced to the chamber 2 from the pressure source 92 is changed from high to low.

Instead of using time as a parameter for controlling the recovery valve 9a, pressure may be so employed. In this case, a pressure detector 24 is provided to detect the pressure in the chamber 2. A pressure value detected by the pressure detector 24 is transmitted to the controller 10, and the controller 10 fully opens the recovery valve 9a when the pressure value reaches a predetermined pressure.

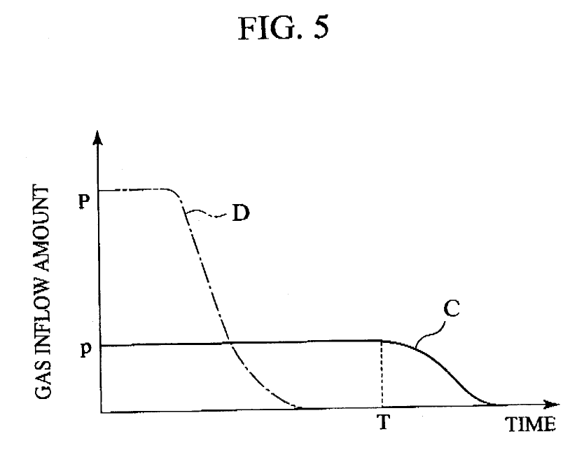

As a result, as is indicated by a solid line C in FIG. 5, during a period beginning with the opening of the recovery valve 9a and ending upon the elapse of the time T, by restricting the gas flow amount through the recovery valve 9a the introduction of gas per unit of time into the chamber 2 changes at a low level p. When the inflow of gas at this low level p has continued until the time T, the pressure in the chamber 2 will have recovered to a considerable gas pressure Therefore, even when, following the elapse of the time T, the controller 10 fully opens the recovery valve 9a, the amount of gas flowing through the inflow pipe 91 will not increase, the pressure in the chamber 2 will be the same as that of the surrounding atmosphere and the vacuum level will have changed until there is no difference between the internal and external pressures, where the pressures are be balanced.

As is described above, the controller 10 controls the recovery valve 9a, so that the resistance to the inflow of gas to the chamber 2 is changed from high to low. Therefore, as is indicated by a long dashed dotted line D in FIG. 5, compared with when a gas from the pressure source 92 is supplied to the chamber 2 without adjustment, the gas flow per unit of time does not reach a high level P. Thus, a phenomenon whereby the dust in the chamber is stirred up by an air stream that enters the chamber 2 during the vacuum venting can be suppressed.

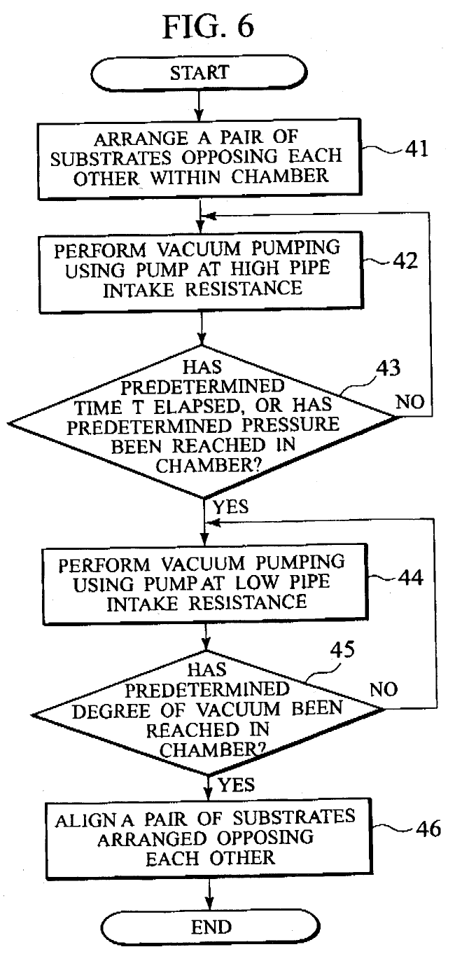

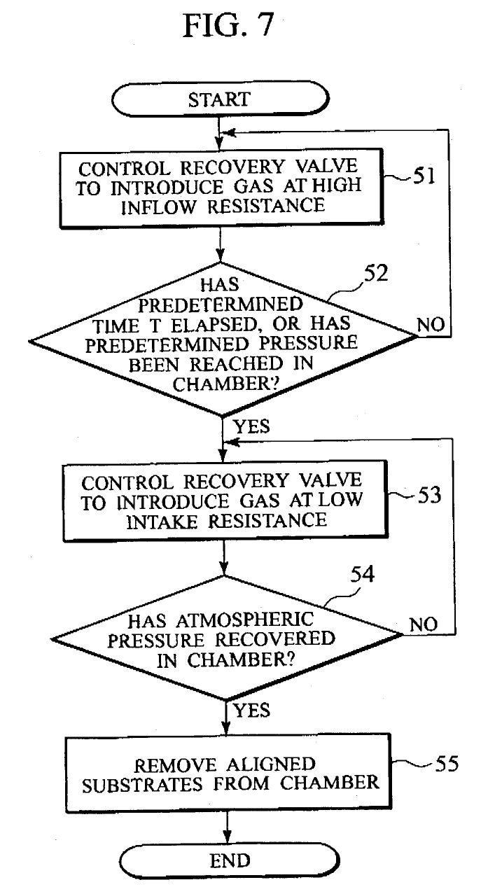

The processing performed by the substrate laminating apparatus according to the first embodiment for laminating the substrate 1a and 1b will be described while referring to the flowcharts in FIGS. 6 and 7.

FIG. 6 is a flowchart showing the processing performed before the laminating of the substrate 1a and 1b. First, at step 41. the paired upper and lower substrates 1a and 1b are arranged opposite each other in the chamber 2, which constitutes a closed space.

At step 42, the controller 10 drives the air exhaust mechanism 8, to adjust the valve 8a, setting a high intake resistance for the pipe 81 and permits the vacuum pump 82 to start the vacuum pumping.

Then, the controller 10 determines whether a predetermined time t has elapsed or the pressure in the chamber 2 has reached to a predetermined value (step 43). When it is ascertained that the predetermined time t has elapsed or the pressure in the chamber has reached to a predetermined value (YES), processing advances to step 44 and the controller 10 adjusts the valve Ba. setting a small intake resistance for the pipe 81, and continues with the vacuum pumping performed by the vacuum pump 82. When, however, it is ascertained at step 43 that the predetermined time t has not elapsed or the pressure in the chamber 2 has not reached to a predetermined value (NO), processing returns to step 42, and vacuum pumping is continued at a high intake resistance.

At step 45, the controller 10 determines whether the vacuum level in the chamber 2 has reached a target vacuum level L. When it is ascertained that the target vacuum level has been obtained (YES), processing advances to step 46, and the oppositely arranged substrates 1a and 1b are positioned and then laminated and pasted with an adhesive interposed therebetween. When, however, it is ascertained at step 45 that the target vacuum level L has not been reached (NO), processing returns to step 44 and vacuum pumping is continued at a low intake resistance.

While referring to FIG. 7, an explanation will now be given for the processing performed beginning with the vacuum venting of the chamber 2 and continuing until the substrates 1a and 1b, which have been laminated in the vacuum. are removed.

First, at step 51, the controller 10 restricts the gas flow through the recovery valve 9a, so that the inflow resistance is high when the gas from the pressure source 92 is introduced into the chamber 2. Then, in the vacuum state, the gas enters the chamber 2.

At step 52, the controller 10 determines whether the predetermined time T has elapsed or the pressure in the chamber has reached to a predetermined value. When it is ascertained that the predetermined time T has elapsed or the pressure in the chamber has reached to a predetermined value (YES), processing advances to step 53, and the controller 10 adjusts the control for the recovery valve 9a so that the Inflow resistance for the gas introduced into the chamber 2 is lower. When, however, it is ascertained that the predetermined time T has not yet elapsed or the pressure in the chamber has not reached to a predetermined value (NO), processing returns to step 51, and the introduction of the gas at the high inflow resistance is continued.

Next. at step 54, the controller 10 determines whether the atmospheric pressure has been recovered in the chamber 2. When it is ascertained that the atmospheric pressure has been recovered (YES), processing advances to step 55 and the upper substrate 1a is released from the upper stage 3a, the upper chamber 2a is elevated, and the substrates 1a and 1b, laminated on the lower stage 3b, are discharged by moving the lower chamber 2b. When, however, it is ascertained at step 54 that the atmospheric pressure has not yet been recovered in the chamber 2, processing returns to step 53 and the introduction of the gas is continued.

According to the first embodiment, in the chamber 2, the air filter 11, which serves as a louver mechanism, is provided opposite the recovery port 23 Therefore, gas entering through the recovery port 23 is dispersed as the direction of flow is changed by the air filter 11, so that the strength at which the gas stream flows into the chamber 2 is further weakened, and the stirring up of dust In the chamber 2 is reduced even more.

As is described above, according to the first embodiment, during the vacuum pumping process for the chamber 2, which is performed for the laminating of the two substrates 1a and 1b, the intake resistance for the pipe 81 connected to the vacuum pump 82 is changed from high to low. Thus, the occurrence in the chamber 2 of a strong exhaust air stream can be avoided, and the stirring up of dust in the chamber 2 can be suppressed.

In addition, according to the first embodiment, for the vacuum venting performed in the chamber 2 after the two substrates 1a and 1b have been laminated, the controller 10 adjusts the recovery valve 9a to change the inflow resistance for the gas flowing into the chamber 2 from high to low. Therefore. the occurrence of a strong air stream in the chamber 2 can be suppressed, and the stirring up of dust in the chamber 2 can be avoided.

Therefore, it is possible to avoid the occurrence of a substrate display functional defect, or a deterioration in the electrical characteristics, resulting from the dust in the chamber 2 being stirred up and attached to the display surfaces of the substrate, or to the substrate electrodes.

In the first embodiment, for the vacuum pumping performed for the chamber 2, the valve 8a, which is provided for the single pipe 81 connected to the vacuum pump 82, is controlled to change the intake resistance for the vacuum pump 82. However, a plurality of pipes having different diameters may be connected between the vacuum pump 82 and the chamber 2, and the overall intake resistance of the pipes may be changed by opening the valves of the individual pipes at different times. The stirring up of dust in the chamber 2 can also be suppressed in this manner.

Similarly, in the vacuum venting process performed for the chamber 2, two inflow pipes having different diameters may be connected between the pressure source 92 and the chamber 2, and the inflow resistance for the gas introduced into the chamber 2 may be changed by opening the recovery valves along the individual pipes at different times. The stirring up of dust in the chamber can also be suppressed in this manner.

Specifically, FIG. 1 is a diagram showing the configuration of a substrate laminating apparatus according to a second embodiment of the present invention. An air exhaust mechanism 8 includes two pipes 81A and 81B. having different diameters, that are connected to a chamber 2 and that are used to change an intake resistance from high to low, and an air supply mechanism 9 includes two inflow pipes 91A and 91B, having different diameters, that are connected to the chamber 2 and that are used to change an inflow resistance from high to low.

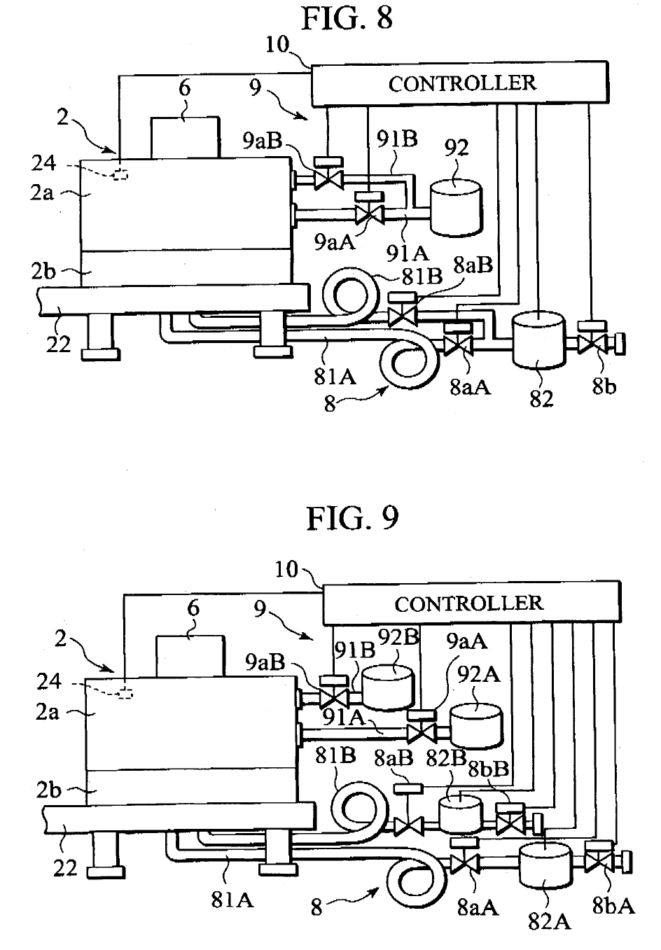

With the configuration shown for the second embodiment in FIG. 8, when a vacuum pump 82 for the air exhaust mechanism 8 is first activated. until a time t is first reached. the controller 10 opens a valve 8aB for the pipe 81B, which has a smaller diameter, and when the time t is reached, it opens a valve 8aA for the pipe 81A, which has a larger diameter. At this time, the controller may close the valve 8aB for the pipe 81B.

Instead of employing time as a parameter for controlling the valves, pressure may be so employed. In this case, a pressure detector 24 is provided for detecting the pressure of the chamber 2. The controller 10 obtains a pressure value detected by the pressure detector 24 and fully opens the valve 8aA when the detected pressure value equals the vacuum level at the time t in FIG. 4.

As a result. since the intake resistance for the vacuum pump 82 is changed from high to low following the time t, similar as in the first embodiment, the occurrence of a strong exhaust air stream can be avoided during the vacuum pumping in the chamber 2, and the substrates can be laminated appropriately.

Likewise, for the air supply mechanism 9, the pressure source 92 is connected to inflow pipes 91A and 91B having different diameters, and during a period until the time T is first reached, the controller 10 opens a recovery valve 9aA for the inflow pipe 91B having a smaller diameter, and when the time T is reached, it opens a recovery valve 9aA for the inflow pipe 91A having a larger diameter. Note, also at this time, the controller 10 may close the recovery valve 9aB for the inflow pipe 91B.

Instead of employing time as a parameter for controlling the valves, pressure may be so employed. In this case, the controller 10 obtains the pressure value detected by the pressure detector 24, and opens the recovery valve 9aA when this pressure value has reached a predetermined pressure.

As a result, since the inflow resistance for a gas introduced into the chamber 2 is changed from high to low following the time T, similar as in the first embodiment, a strong inflow air stream does not occur in the chamber 2 during the process performed to recover the atmospheric pressure in the chamber 2, and the attachment of dust to the laminated substrate can be avoided.

Since the structure of the chamber 2 in FIG. 8 is the same as that in FIG. 3, an air filter 11 provided in an upper chamber 2a can reduce the force of the inflow gas stream.

In this configuration for the second embodiment, since the procedures (steps) beginning with the vacuum pumping in the chamber 2 and continuing to the vacuum venting following the substrate laminating are the same as those for the first embodiment as shown in FIGS. 6 and 7, no further explanation for them will be given.

In the first and second embodiments, the single vacuum pump 82 is connected to control the valves 8a, 8aA and 8aB, to allow the overall intake resistance along the pipes to be changed from high to low. However, for the air exhaust mechanism 8, multiple vacuum pumps may be arranged in parallel to change the total intake capability of the pumps from low to high.

FIG. 9 is a diagram showing the configuration of a substrate laminating apparatus according to a third embodiment of the present invention. An air exhaust mechanism 8 is configured so that two vacuum pumps 82A and 82B, having different intake capabilities (the gas intake amount per unit of time (1/min) that is available), are respectively coupled with two pipes 81A and 81B, having the same diameters, connected to a chamber 2.

Until the time t is reached, a controller 10 holds open a valve 8aB provided for a pipe 81B to which the vacuum pump 82A having a smaller intake capability is connected, and when the time t has elapsed. the controller 10 closes the valve 8aB and opens a valve 8aA provided for a pipe 81A to which the vacuum pump 82A having a higher intake capability is connected Note. both the valve 8aA and the valve 8aB may be opened after the time t has elapsed.

Instead of using time as a parameter to control the valves, pressure (vacuum level) may be so employed. In this case, a pressure detector 24 is provided for detecting the pressure in a chamber 2. The controller 10 obtains a pressure value detected by the pressure detector 24 and closes the valve 8aB and opens the valve 8aA when the detected pressure value is the vacuum level corresponding to that at the time t in FIG. 4.

In addition, instead of the valves 81A, 8aB, exhaust valves 8bA and 8bB can be used for changing the intake capability of the pumps.

Therefore, for the overall air exhaust mechanism 8, the intake capabilities of the pumps 82A and 82B are changed from low to high following the time t, and during the vacuum pumping performed for the chamber 2, the occurrence of a strong exhaust air stream and the stirring up of dust in the chamber can be avoided.

In the third embodiment, for an air supply mechanism 9 also, two pressure sources 92A and 92B having same inflow resistance are arranged, and from the initiation of the air supply until the time T is reached, the controller 10 holds open only a recovery valve 9aB, provided for an inflow pipe 91B, and after the time T has elapsed, also opens a recovery valve 9aA, provided for the other inflow pipe 91A.

Instead of using time as a parameter for controlling the valves, pressure may be so employed by the controller 10. In this case, the controller 10 obtains a pressure value detected by the pressure detector 24, and when the pressure value has reached a predetermined pressure, opens both the recovery valves 9aA and 9aB.

As a result, during the vacuum venting performed for the chamber 2, since the inflow resistances for a gas introduced from the pressure sources are changed from high to low, similar as in the first and second embodiments, it is possible to avoid the attachment of the dust to the electrode faces of the laminated substrates and defects such as electric characteristics deterioration resulting from the stirring up of the dust in the vacuum chamber 2. It should be noted that. in FIG. 9, exhaust valves 8bA and 8bB are provided for the vacuum pumps 82A and 82B.

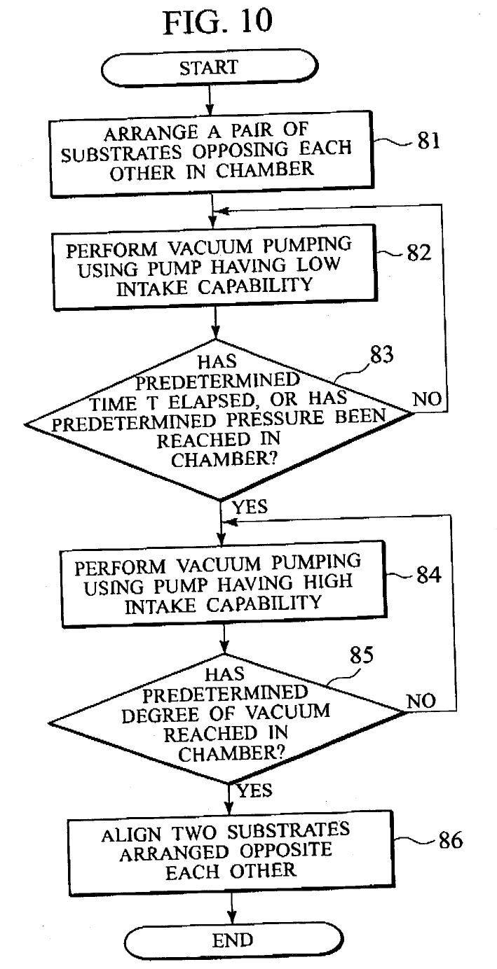

In the third embodiment, from among the processing performed beginning with the vacuum pumping in the chamber 2 and continuing to the vacuum venting performed following the substrate laminating, those processes performed up until the substrate laminating will be described while referring to FIG. 10.

Steps 81 to 86 in FIG. 10 correspond to steps 41 to 46 in FIG. 6. Differences from the steps in FIG. 6 are that at step 82 vacuum pumping is performed by a vacuum pump having a small intake capability, while at step 42 vacuum pumping is performed at a high intake resistance, and at step 84 vacuum pumping is performed by a vacuum pump having a large intake capability, while at step 44 vacuum pumping Is performed at a low intake resistance. However, since the objective and the function of vacuum pumping are commonly employed, and there is no difference in the performance of the processing, no detailed explanation will be given.

Furthermore, since the vacuum venting step in the third embodiment is also the same as that in FIG. 7 for the first embodiment, no further explanation for this will be given.

Therefore, also in the third embodiment, a strong exhaust air stream does not occur in the chamber during the vacuum pumping, and the stirring up of dust is avoided as much as possible. Further, during the vacuum venting process, the occurrence of a strong air inflow stream and the attachment of dust to the electrode faces can be avoided, so that an appropriately laminated substrate can be manufactured.

In the second or third embodiment, the two pipes 81A, 81B and the two inflow pipes 91A, 91B, or the two vacuum pumps 82A, 82B and the two pressure sources 92A, 92B are provided. However, arrangements of three or more of these components are possible.

Further, in the third embodiment, the pump intake capability may be changed from low to high by changing the intake capability of a single vacuum pump. In this case, either only the degree of opening for the exhaust valves 8bA and 8bB in FIG. 9 need be changed from small to large. or only the rotational speed of a motor for driving the vacuum pump need be changed from slow to fast.

A fourth embodiment of the present invention will be described while referring to FIGS. 8, 11 and 12.

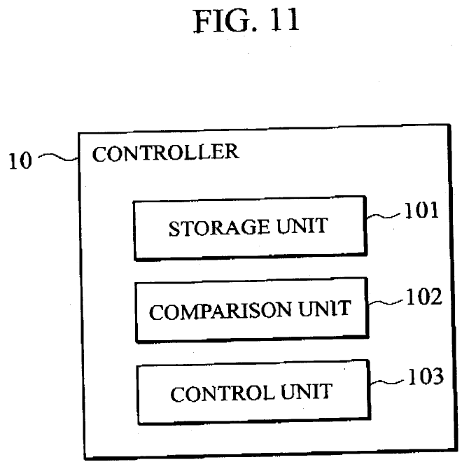

A controller 10 in FIG. 8 includes a storage unit 101, a comparison unit 102 and a control unit 103, as shown in FIG. 11. In the storage unit 101, a relationship between the time elapsed since the start of the vacuum pumping for the chamber 2 and a target value for the internal pressure of the chamber 2 corresponding to the elapsed time is stored as such a graph as that in FIG. 4 or in a correlation table. The vacuum pump 82 has the pump intake capability in which the internal pressure of the chamber 2 corresponding to the elapsed time is over the curve shown in FIG. 4 when the valve 8aA and/or 8aB is always open.

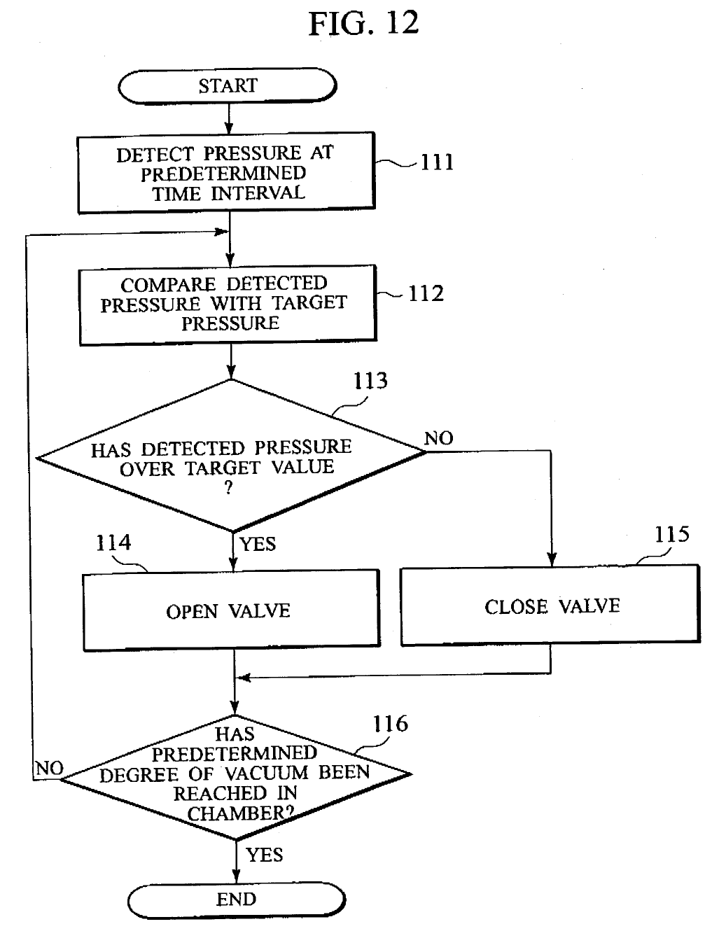

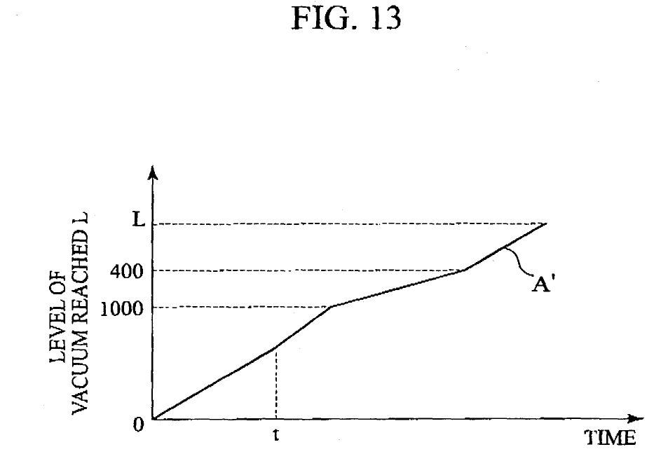

When the vacuum pumping for the chamber 2 is started, as is shown in FIG. 12. a pressure detector 24 detects, at predetermined time intervals, the pressure in the chamber 2 (step 111) and transmits the detected pressure value to the controller 10. The comparison unit 102 of the controller 10 compares the detected pressure value with the target pressure value, which corresponds is to the time elapsed since the start of the vacuum pumping, stored in the storage unit 101 (step 112), and when the detected pressure value is equal to or smaller than the target pressure value, a valve 8aA and/or a valve 8aB are opened (steps 113 and 114). When the detected pressure value exceeds the target pressure value, the control unit 103 closes the valve 8aA and/or the valve 8aB (steps 113 and 115). Then, the comparison unit 102 decides whether or not the internal pressure in the chamber 2 has reached the target vacuum level L (steps 116). If the target vacuum level L has not been reached, then the flow returns to the step 112 to repeat the steps. If the target vacuum level L has been reached, then the flow ends.

By repeating this processing, the controller 10 can change the internal pressure of the chamber 2 to be in line with the target value. In the same manner, an air supply mechanism for opening and closing recovery valves 91aA and 91aB can be controlled by storing a relationship between the time elapsed since the start of the air supply for the chamber 2 and a target value for the gas inflow amount of the chamber 2 corresponding to the elapsed time as that in FIG. 5 is stored in the storage unit 101.

This valve control may be performed in parallel to the control described for the second embodiment. That is, while performing the control process in the fourth embodiment, the controller 10 performs the steps 113 to 116 by control the valve 8aB until the time t is reached, and performs the steps 113 to 116 by control the valve 8aA when the time t has been reached. Further, instead of using time, the internal pressure of the chamber 2 may be employed as a parameter for performing the steps 113 to 116 by opening or closing the valves 8aA and/or 8aB.

Also, for the first and the third embodiments, as well as the second embodiment, the control process for the fourth embodiment can be performed in parallel.

A fifth embodiment of the present invention will be described while referring to FIGS. 8, 11, 12 and 13.

In FIG. 8, when the upper substrate la is held to the upper stage 3a through an electrostatic retention and vacuum retention, between an upper stage 3a in a chamber 2 and an upper substrate 1a held to the upper stage 3a, a tiny space is defined due to distortion of the upper substrate la or a variance in the thickness thereof, and air is enclosed in this space. The following has been confirmed through experimentation. The air enclosed in this space tries to escape to the chamber 2 between the upper stage 3 and the upper substrate la within the pressure range depending on the conditions such as holding force of the upper substrate la through electrostatic retention and vacuum retention and size of the upper substrate 1a. For example, in the case where the upper substrate la has the size of 1500 mm×1200 mm and the weight of 3 Kg, the electrostatic retention force is 5g/Cm², the suction force by the vacuum retention is 1000 Pa, there is a clearance of approximately 10μm between the upper substrate 1a and the upper stage 3a, so long as the pressure in the chamber 2 ranges from that of the atmospheric pressure (about 100000 Pa) to 1000 Pa, the force with which the upper substrate 1a is pressed against the upper stage 3a when electrostatic retention and vacuum retention is used is greater than the force exerted by the expanding air that widens the gap between the upper stage 3a and the upper substrate 1a, and almost all the air is retained in the space. But at about the time at which the pressure in the chamber 2 reaches 1000 Pa, the escape force exerted by the air is greater than the electrostatic retention force that presses the upper substrate la against the upper stage 3a, and the escape of the air becomes noticeable. Then, by the time at which the pressure in the chamber 2 reaches 400 Pa, most of the air has escaped.

Further, it has been confirmed that when the pressure is suddenly reduced from 1000 Pa to 400 Pa, the electrostatically retained lower substrate la drops from the upper stage 3a. This is because, due to the sudden pressure reduction within the above described pressure range, all the air enclosed between the upper stage 3 and the upper substrate la immediately escapes into the chamber 2, and the huge force produced by the high speed of the air stream as it escapes from between the upper stage 3a and the upper substrate 1a separates the upper substrate 1a from the upper stage 3a. It is assumed that the force will cause the electrostatically retained upper substrate 1a to drop from the upper stage 3a, and since the lower substrate 1b is mounted on the lower stage 3b to which the upper substrate 1a drops, the upper substrate 1b will strike the lower substrate 1b. As a result, there is a risk that both the substrates 1a and 1b will be damaged and rendered detective.

Therefore, within the pressure range of from 1000 Pa to 400 Pa for the chamber 2, compared with another pressure range (from the atmospheric pressure to about 1000 Pa, or from 400 Pa to about 1 Pa), the pressure change rate is reduced by controlling the valves so that the air is gradually released from the gap between the upper stage 3a and the upper substrate 1a. As a result, the speed of air flow escaping from the gap between the upper stage 3a and the upper substrate 1a can be moderated, and a phenomenon is prevented whereby the upper substrate 1a held on the upper stage 3a is dropped as the vacuum pumping for the chamber 2 is performed.

Therefore, In the fifth embodiment, the storage unit 101 in the controller 10 stores the graph or correlation table In which, within the pressure range of from 1000 Pa to 400 Pa for the chamber 2, compared with another pressure range (from the atmospheric pressure to about 1000 Pa, or from 400 Pa to about 1 Pa), the pressure change rate is reduced. as is shown in FIG. 13. Similarly to the fourth embodiment, in accordance with the flow shown in FIG. 12, the valve 8dA and/or valve 8aB are opened or closed so that the internal pressure in the chamber 2 is controlled along the graph of FIG. 13.

The controller 10 repeats this processing, controlling the valves, so that the rate of the internal pressure change in the chamber 2 is smaller in the 1000 Pa to 400 Pa range than in another pressure range (from the atmospheric pressure to about 1000 Pa, or 400 Pa to about 1 Pa).

Therefore the speed of the air flow escaping from the gap between the upper stage 3a and the upper substrate 1a can be moderated, and the occurrence of a phenomenon can be prevented whereby the upper substrate 1a, electrostatically retained on the upper stage 3a, is dropped as the vacuum pumping is performed in the chamber 2.

The above described control process can be performed in parallel to the processes in the first, the second and the third embodiments.

In addition, the pressure range, in which air mainly escapes from the space between the upper substrate 1a and the upper stage 3a, is between substantially 1000 Pa and 400 Pa. However, if the conditions such as the electrostatic retention force change, the pressure in which air starts to remarkably escape change to upper side or lower side relative to 1000 Pa, and the pressure in which almost air escape change to upper side or lower side relative to 400 Pa. Thus, the pressure change rate is not always reduced in the whole rage between 1000 Pa and 400 Pa. The pressure change rate may be reduced in the necessary minimum range In accordance with the conditions such as the electrostatic retention force.

In addition, on some condition such as electrostatic retention force and substrates, air can escape from the space between the substrate and the stage by keeping the internal pressure in the chamber 2 at some constant value within the range of 1000 Pa to 400 Pa for a predetermined time, so that a substrate drop preventing effect can be obtained.

In the first embodiment, the valve 8a and the recovery valve 9a were opened in two steps, However, the same functions can be realized by employing three steps to open these valves in three steps, or opening them linearly, instead of step by step.

The valve control process in the first embodiment may be employed for controlling the valves in the second embodiment.

Moreover, the air exhaust mechanism a and the air supply mechanism 9 in each of the embodiments may be selectively combined and employed

As a conclusion, according to the substrate laminating apparatus and the substrate laminating method of the invention, appropriate substrate laminating can be performed while avoiding, to the extent possible, the deterioration of the electric characteristics of the substrates by the attachment of dust to the display surfaces or to the electrode faces of the substrates. Especially, when the substrate laminating apparatus and the method therefor are employed for manufacturing a liquid crystal display panel, the manufacturing yield can be improved, and noticeable effects can be practically obtained. As described above, according to the substrate laminating apparatus and the substrate laminating method of the present invention, a high-quality substrate laminating can be implemented. and especially in the manufacture of a liquid crystal display panel great effects can be obtained by applying the present invention.

In addition, according to the substrate laminating apparatus and the substrate laminating method of the present invention, an upper substrate can be prevented from dropping due to vacuum pumping performed in a chamber.

What is claimed is:

1. A substrate laminating apparatus for laminating two substrates in a closed chamber comprising:
a pump being connected to the chamber to perform vacuum pumping in the chamber; and
a controller for controlling a valve of a pipe connecting the pump to the chamber to change an intake resistance of the pipe.

2. A substrate laminating apparatus according to claim 1, wherein the controller controls the valve so as to change the intake resistance from high to low.

3. A substrate laminating apparatus for laminating two substrates in a closed chamber comprising;
a pump connected to a chamber to perform vacuum pumping; and
a controller for controlling a recovery valve communicating with a recovery port opening in the chamber, and for changing an inflow resistance of a gas flowing into the chamber.

4. A substrate laminating apparatus according to claim 3, wherein, before the laminating of the two substrates, the controller controls the valve on the pipe connecting the chamber to the pump, so as to change the inflow resistance of the pipe from high to low.

5. A substrate laminating apparatus according to claim 3. wherein the chamber has a louver mechanism for changing the direction in which a gas flows from the recovery port into the chamber.

6. A substrate laminating method for laminating two substrates in a closed chamber comprising:
a first step of arranging a pair of substrates in the closed chamber, so that the substrates are opposing each other and keeping a space therebetween:
a second step, following the completion of the first step, of operating a pump connected to the chamber at a predetermined intake resistance, and of starting vacuum pumping in the chamber;
a third step of controlling a valve on a pipe connecting the pump to the chamber, so that the intake resistance of the pipe Is reduced when a predetermined period of time has elapsed or the pressure inside the chamber has reached to a predetermined pressure following the start of the vacuum pumping at the second step:
a fourth step, following the completion of the third step, of laminating the two substrates arranged opposing each other in the chamber;
a fifth step, following the completion of the fourth step. of controlling a recovery valve communicating with a recovery port opening into the chamber, introducing a gas into the chamber at a predetermined inflow resistance. and shifting the internal gas pressure in the chamber toward the atmosphere pressure; and
a sixth step, following the completion of the fifth step, of removing the two laminated substrates from the chamber,

7. A substrate laminating method according to claim 6, wherein at the fifth step, the recovery valve is controlled so that the inflow resistance of a gas introduced into the chamber is changed from high to low.

8. A substrate laminating apparatus for laminating two substrates In a closed chamber comprising:
a pump connected to the chamber to perform vacuum pumping for the chamber; and
a controller for changing an intake capability of the pump.

9. A substrate laminating apparatus method according to claim 8, wherein the controller controls the intake capacity from low to high.

10. A substrate laminating apparatus according to claim 8, wherein, after the laminating of the two substrates, the controller controls the recovery valve communicating with a recovery port opening in the chamber, so that the inflow resistance of a gas introduced into the chamber is changed from high to low.

11. A substrate laminating apparatus according to claim 10, wherein the chamber has a louver mechanism for changing the direction in which a gas flows into the chamber through the recovery port.

12. A substrate laminating method for laminating two substrates in a closed chamber comprising:
a first step of arranging a pair of substrates in the chamber, so that the substrates are opposing each other, at an interval;
a second step, following the completion of the first step, of operating a pump, connected to the chamber and having a predetermined intake capability, and beginning vacuum pumping for the chamber;
a third step of controlling the pump, an exhaust valve of the pump, or a valve of a pipe connecting the pump to the chamber, so that the intake capability of the pump is increased after a predetermined period of time has elapsed following the start of the vacuum pumping at the second step or the pressure of the chamber has reached to a predetermined pressure:
a fourth step, following the completion of the third step, of laminating the two substrates arranged opposing each other in the chamber;
a fifth step, following the completion of the fourth step, of controlling a recovery valve, which communicates with a recovery port opening in the chamber, so as to introduce a gas into the chamber at a predetermined inflow resistance, and of shifting the gas pressure in the chamber to the atmospheric pressure; and
a sixth step, following the completion of the fifth step, of removing the two laminated substrates from the chamber.

13. A substrate laminating method according to claim 12, wherein, at the fifth step, the recovery valve communicating with a recovery port opening in the chamber is controlled, so that the inflow resistance of a gas introduced Into the chamber is changed from high to low.

14. A substrate laminating apparatus according to claim 1. further comprising:
a pressure detector for detecting the pressure in the chamber at a predetermined time interval,
wherein the controller includes
a storage unit for storing a relationship between an elapsed time following a vacuum pumping start for the chamber and a target pressure value for the chamber corresponding to the elapsed time,
a comparison unit for comparing a pressure value detected by the pressure detector with the target pressure value stored in the storage unit, and
a control unit for controlling the valve in accordance with a comparison result by the comparison unit.

15. A substrate laminating method according to claim 6, further comprising:
a seventh step of storing a relationship between an elapsed time following a vacuum pumping start for the chamber and a target pressure value for the chamber corresponding to the elapsed time;
an eighth step. following the completion of the second step, of detecting the pressure in the chamber at a predetermined time interval;
a ninth step of comparing a pressure value detected at the eighth step with the target pressure value stored at the seventh step; and
a tenth step of controlling the valve in accordance with a comparison result by the comparison unit.

16. A substrate laminating apparatus according to claim 14, wherein the relationship between an elapsed time following a vacuum pumping start for the chamber and a target pressure value for the chamber corresponding to the elapsed time comprises a relationship in which a pressure change rate per time in a predetermined pressure range is less than that of a range out of the predetermined pressure range.

17. A substrate laminating apparatus according to claim 16, wherein the predetermined pressure range comprises a range of 1000 Pa to 400 Pa.

18. A substrate laminating apparatus according to claim 15. wherein the relationship between an elapsed time following a vacuum pumping start for the chamber and a target pressure value for the chamber corresponding to the elapsed time comprises a relationship in which a pressure change rate per time in a predetermined pressure range is less than that of a range out of the predetermined pressure range.

19. A substrate laminating apparatus according to claim 18, wherein the predetermined pressure range comprises a range of 1000 Pa to 400 Pa.
